(19) United States
(12) Patent Application Publication
(10) Pub. No.: US 2009/0011335 A1
(43) Pub. Date: Jan. 8, 2009

(54) Positive electrode active material, method of manufacturing the positive electrode active material, and non-aqueous electrolyte secondary battery

(76) Inventors: Katsutoshi Takeda, Osaka (JP); Motoharu Saito, Osaka (JP); Hiroshi Sawada, Nisshin-shi (JP); Masahisa Fujimoto, Osaka (JP)

Correspondence Address: KUBOVCIK & KUBOVCIK, SUITE 1105, 1215 SOUTH CLARK STREET, ARLINGTON, VA, 22202, US

(21) Appl. No.: 12/213,886

(22) Filed: Jun. 25, 2008

(30) Foreign Application Priority Data
Jun. 25, 2007 (JP) 2007-165821

(51) Int. Cl. H01M 4/52; H01M 4/50; H01M 4/26

(52) U.S. Cl. 429/223; 429/224; 429/231.95

(57) ABSTRACT

A high-capacity positive electrode active material is provided that enables a non-aqueous electrolyte secondary battery to have excellent load characteristics and high initial charge-discharge efficiency. A non-aqueous electrolyte secondary battery has a positive electrode, a negative electrode, and a non-aqueous electrolyte, and performs charge and discharge by transferring lithium ions between the positive electrode and the negative electrode. The positive electrode has a positive electrode mixture and a positive electrode current collector. The positive electrode mixture contains a positive electrode active material, a conductive agent, and a binder agent (binder). The positive electrode active material includes Li₁₊ₓ₋ₐ(Mn_{y}M_{1-y})₁₋ₓO_{2±b}, where 0<a<0.3, 0<b<0.1, 0<x<0.4, 0<y<1, and 0.95<1+x−a<1.15, and M is at least one transition metal other than manganese (Mn).

### BACKGROUND OF THE INVENTION

1. Field of the Invention

The present invention relates to non-aqueous electrolyte secondary batteries and positive electrode active materials used therefor.

2. Description of Related Art

Currently, lithium secondary batteries are widely used as high-energy density secondary batteries. A lithium secondary battery uses a non-aqueous electrolyte and performs charge-discharge operations by transferring ions such as lithium ions between its positive and negative electrodes.

In this type of non-aqueous electrolyte secondary battery, the positive electrode is typically composed of a layered lithium cobalt oxide (LiCoO₂), and the negative electrode is typically composed of a material capable of intercalating and deintercalating lithium ions, such as a carbon material, metallic lithium, and a lithium alloy. The non-aqueous electrolyte typically contains an electrolyte salt such as lithium tetrafluoroborate (LiBF₄) or lithium hexafluorophosphate (LiPF₆) dissolved in an organic solvent such as ethylene carbonate or diethyl carbonate.

The use of cobalt (Co), however, leads to high manufacturing costs because Co is an exhaustible and scarce natural resource. For this reason, use of an alternative positive electrode material to lithium cobalt oxide, such as lithium manganese oxide (LiMn₂O₄) and lithium nickel oxide (LiNiO₂) has been investigated. The use of LiMn₂O₄, however, presents some problems such as insufficient discharge capacity and dissolution of manganese at a high battery temperature. On the other hand, LiNiO₂ has the problem of poorer thermal safety than LiCoO₂.

Under such circumstances, lithium-excess transition metal oxides such as represented by Li₂MnO₃ have drawn attention as high energy density positive electrode materials because they have a layered structure like LiCoO₂ and contain lithium (Li) in the transition metal layer in addition to the lithium (Li) layer and contain a large amount of Li involved in charge-discharge operations. (See, for example, C. S. Johnson et al., Electrochemistry Communications, 6(10), 1085-1091 (2004), and Y. Wu and A. Manthiram, Electrochemical and Solid-State Letters, 9(5) A221-A224, (2006).)

The lithium-excess transition metal oxides are represented by the general formula Li₁₊ₓM₁₋ₓO₂ (where M includes Mn and at least one metal element selected from Co, Ni, Fe, and the like), and they yield varied working voltages and capacities depending on the type of the metal element M. This provides significant advantages. For example, the battery voltage can be freely selected by selecting the element M. In addition, a large battery capacity per unit mass can be achieved because their theoretical capacity is relatively high, from about 340 mAh/g to 460 mAh/g.

However, a non-aqueous electrolyte secondary battery employing the lithium-excess transition metal oxide as the positive electrode active material shows an initial charge-discharge efficiency of only about 50% to about 85%, which is lower than that of the conventional non-aqueous electrolyte secondary battery employing LiCoO₂ as the positive electrode active material (which is about 95%). This means that the lithium ions that are not involved in charge and discharge are transferred from the positive electrode to the negative electrode, so a greater amount of negative electrode material is required than that is required for the conventional non-aqueous electrolyte secondary battery. As a consequence, this non-aqueous electrolyte secondary battery tends to have a poor gravimetric energy density and a poor volumetric energy density.

Although the Y. Wu and A. Manthiram publication discloses a method for improving initial charge-discharge efficiency by coating the surface of the positive electrode active material with aluminum oxide (Al₂O₃), this method does not improve the initial charge-discharge efficiency sufficiently (only about an initial charge-discharge efficiency of 87% is obtained). Moreover, the method proposed by Y. Wu and A. Manthiram results in poorer load characteristics in the non-aqueous electrolyte secondary battery.

It is an object of the present invention to provide a high-capacity positive electrode active material and a method of manufacturing the positive electrode active material that enable a non-aqueous electrolyte secondary battery to have excellent load characteristics and a high initial charge-discharge efficiency.

It is another object of the present invention to provide a high-capacity non-aqueous electrolyte secondary battery that achieves excellent load characteristics and a high initial charge-discharge efficiency.

### BRIEF SUMMARY OF THE INVENTION

In order to accomplish the foregoing and other objects, the present invention provides

(1) A positive electrode active material according to a first aspect of the invention which is a positive electrode active material comprising a lithium-containing oxide comprising Li₁₊ₓ₋ₐ(Mn_{y}M_{1-y})₁₋ₓO_{2±b} where 0<a<0.3, 0<b<0.1, 0<x<0.4, 0<y<1, and 0.95<1+x−a<1.15, and M is at least one transition metal other than manganese.

In this positive electrode active material, the amount of lithium per 1 mol is within an appropriate range (0.95<1+x−a<1.15). Therefore, when this positive electrode active material is used for the positive electrode of a non-aqueous electrolyte secondary battery, the difference between the amount of lithium ions (Li⁺) extracted from the positive electrode during charge and the amount of lithium ions inserted into the positive electrode during discharge can be made smaller. This makes it possible to improve the load characteristics and the initial charge-discharge efficiency of the non-aqueous electrolyte secondary battery, while at the same time maintaining a high capacity.

(2) The lithium-containing oxide may comprise Li₁₊ₓ₋ₐ(Mn_{y}Ni_{z}Co_{1-y-z})₁₋ₓO_{2±b}, where 0<a<0.3, 0<b<0.1, 0<x<0.4, 0<y<1, 0≦z≦1, and 0.95<1+x−a<1.15.

When this positive electrode active material is used for the positive electrode of a non-aqueous electrolyte secondary battery, the load characteristics and the initial charge-discharge efficiency of the non-aqueous electrolyte secondary battery can be improved sufficiently while at the same time a high capacity is maintained.

(3) The lithium-containing oxide may comprise Li_{c}Mn_{0.54}Ni_{0.13}Co_{0.13}O_{2±b}, where 0<b<0.1 and 0.98<c<1.15.

When this positive electrode active material is used for the positive electrode of a non-aqueous electrolyte secondary battery, the load characteristics and the initial charge-discharge efficiency of the non-aqueous electrolyte secondary battery can be improved reliably while at the same time a high capacity is maintained.

(4) The positive electrode active material may have a true density of from 4.25 g/cm³ to 4.28 g/cm³. When this positive electrode active material is used for the positive electrode of a non-aqueous electrolyte secondary battery, the load characteristics and the initial charge-discharge efficiency of the non-aqueous electrolyte secondary battery can be improved further while at the same time a high capacity is maintained.

(5). According to a second aspect, the present invention provides a method of manufacturing a positive electrode active material from a lithium-containing oxide, comprising: treating the lithium-containing oxide with an aqueous acid solution, wherein the lithium-containing oxide comprises Li₁₊ₓ(Mn_{y}M_{1-y})₁₋ₓO₂, where 0<x<0.4 and 0<y<1, and M includes at least one transition metal other than manganese, and the amount of hydrogen ions in the aqueous acid solution is from x mol to less than 5x mol per 1 mol of the lithium-containing oxide.

This manufacturing method yields a positive electrode active material represented by Li₁₊ₓ₋ₐ(Mn_{y}M_{1-y})₁₋ₓO_{2±b} where 0<a<0.3, 0<b<0.1, 0<x<0.4, 0<y<1, and 0.95<1+x−a<1.15, and M is at least one transition metal other than manganese. In this positive electrode active material, the amount of lithium per 1 mol is within an appropriate range (0.95<1+x−a<1.15). Therefore, when the positive electrode active material manufactured according to this method is used for the positive electrode of a non-aqueous electrolyte secondary battery, the difference between the amount of lithium ions (Li⁺) extracted from the positive electrode during charge and the amount of lithium ions inserted into the positive electrode during discharge can be made smaller. This makes it possible to improve the load characteristics and the initial charge-discharge efficiency of the non-aqueous electrolyte secondary battery, while at the same time maintaining a high capacity.

(6) The aqueous acid solution may be an aqueous nitric acid solution. This makes it possible to prevent impurities from remaining in the lithium compound. As a result, the load characteristics of the non-aqueous electrolyte secondary battery can be improved further.

(7) The above-described method of manufacturing a positive electrode active material may further comprise, after the step of treating the lithium-containing oxide with an aqueous acid solution, a step of heat treating the lithium-containing oxide in an atmosphere at 250° C. or higher.

This allows hydrogen ions in the lithium-containing oxide produced by ion exchange with lithium ions to be extracted as H₂O by ion exchange with lithium ions in the step of treating the lithium-containing oxide with an aqueous acid solution. As a result, the load characteristics of the non-aqueous electrolyte secondary battery can be improved sufficiently.

(8) In accordance with a third aspect, the present invention provides a non-aqueous electrolyte secondary battery comprising a positive electrode containing a positive electrode mixture, a negative electrode, and a non-aqueous electrolyte, wherein the positive electrode mixture contains the positive electrode active material according to the first aspect of the invention.

This non-aqueous electrolyte secondary battery uses, as the positive electrode active material, a lithium-containing oxide comprising Li₁₊ₓ₋ₐ(Mn_{y}M_{1-y})₁₋ₓO_{2±b}, where 0<a<0.3, 0<b<0.1, 0<x<0.4, 0<y<1, and 0.95<1+x−a<1.15, and M is at least one transition metal other than manganese.

In this case, the amount of lithium per 1 mol of the positive electrode active material is within an appropriate range (0.95<1+x−a<1.15). Therefore, the difference between the amount of lithium ions (Li⁺) extracted from the positive electrode during charge and the amount of lithium ions inserted into the positive electrode during discharge can be made smaller. This makes it possible to improve the load characteristics and the initial charge-discharge efficiency of the non-aqueous electrolyte secondary battery, while at the same time maintaining a high discharge capacity.

(9) The positive electrode mixture may have a filling density of from greater than 2.5 g/cm³ to 3.6 g/cm³. In this case, the load characteristics of the non-aqueous electrolyte secondary battery can be improved further.

(10) The positive electrode mixture layer may have a thickness of 40 μm or less. In this case, the load characteristics of the non-aqueous electrolyte secondary battery can be improved sufficiently.

According to the present invention, the amount of lithium per 1 mol of the positive electrode active material is within an appropriate range (0.95<1+x−a<1.15). Therefore, the difference between the amount of lithium ions (Li⁺) extracted from the positive electrode during charge and the amount of lithium ions inserted into the positive electrode during discharge can be made smaller. This makes it possible to improve the load characteristics and the initial charge-discharge efficiency of the non-aqueous electrolyte secondary battery, while at the same time maintaining a high discharge capacity.

### BRIEF DESCRIPTION OF THE DRAWINGS

FIG. 1 is a schematic drawing illustrating a test cell of a non-aqueous electrolyte secondary battery according to one embodiment of the invention; and

FIG. 2 is a graph illustrating the relationship between discharge capacity density versus discharge rate for the test cells of Examples 7 and 8.

### DETAILED DESCRIPTION OF THE INVENTION

Hereinbelow, a positive electrode active material and a non-aqueous electrolyte secondary battery furnished with a positive electrode containing the positive electrode active material, according to one embodiment of the present invention, will be described in detail with reference to the drawings.

The non-aqueous electrolyte secondary battery according to the present embodiment has a positive electrode, a negative electrode, and a non-aqueous electrolyte, and performs charge and discharge by transferring lithium ions between the positive electrode and the negative electrode.

It should be noted that the types of materials and various parameters including thickness of the materials, concentrations, and so forth are not limited to those described in the following description, but may be determined as appropriate.

(1) Positive Electrode

The positive electrode comprises a positive electrode mixture and a positive electrode current collector. The positive electrode current collector is made of, for example, a metal foil such as an aluminum foil.

The positive electrode mixture contains a positive electrode active material, a conductive agent, and a binder agent (binder). Li₁₊ₓ₋ₐ(Mn_{y}M_{1-y})₁₋ₓO_{2±b} where 0<a<0.3, 0<b<0.1, 0<x<0.4, 0<y<1, and 0.95<1+x−a<1.15, and M is at least one transition metal other than manganese (Mn) is used as the positive electrode active material.

In this positive electrode active material, the amount of lithium per 1 mol of the positive electrode active material is within an appropriate range (0.95<1+x−a<1.15). Therefore, the difference between the amount of lithium ions (Li⁺) extracted from the positive electrode during charge and the amount of lithium ions inserted into the positive electrode during discharge can be made smaller. This makes it possible to improve the load characteristics and the initial charge-discharge efficiency of the non-aqueous electrolyte secondary battery, while at the same time maintaining a high capacity.

The Li₁₊ₓ₋ₐ(Mn_{y}M_{1-y})₁₋ₓO_{2±b} should preferably be Li₁₊ₓ₋ₐ(Mn_{y}Ni_{z}Co_{1-y-z})₁₋ₓO_{2±b} where 0<a<0.3, 0<b<0.1, 0<x<0.4, 0<y<1, 0<z<1, 0.95<1+x−a<1.15, and more preferably Li_{c}Mn_{0.54}Ni_{0.13}Co_{0.13}O_{2±b} where 0<b<0.1 and 0.98<c<1.15.

In this case, the difference between the amount of lithium ions extracted from the positive electrode during charge and the amount of lithium ions inserted into the positive electrode during discharge can be made further smaller. As a result, the load characteristics and the initial charge-discharge efficiency of the non-aqueous electrolyte secondary battery can be improved further. As a result, the initial charge-discharge efficiency can reach 90% to 99%.

The true density of the positive electrode active material is, for example, from about 4.25 g/cm³ to about 4.28 g/cm³. Thus, the true density of the positive electrode active material according to the present embodiment is higher than that of the conventional positive electrode active material Li₁₊ₓM₁₋ₓO₂, which is not subjected to the acid treatment. As a result, the non-aqueous electrolyte secondary battery is allowed to have a high energy density.

The positive electrode active material according to the present embodiment is manufactured as follows. A lithium-excess transition metal oxide Li₁₊ₓ(Mn_{y}M_{1-y})₁₋ₓO₂ (0<x<0.4, 0<y<1, and M is at least one transition metal other than manganese (Mn)) is subjected to an acid treatment with an aqueous acid solution, then washed with water, and thereafter heat-treated in an air atmosphere at 250° C. or higher.

It is preferable that the amount of hydrogen ions in the aqueous acid solution used for the acid treatment be in the range of from x mol to less than 5x mol (where 0<x<0.4) per 1 mol of the lithium-excess transition metal oxide Li₁₊ₓ(Mn_{y}M_{1-y})₁₋ₓO₂. For example, when performing the acid treatment of 2 mol of the Lithium-excess transition metal oxide Li₁₊ₓ(Mn_{y}M_{1-y})₁₋ₓO₂, it is preferable that the aqueous acid solution contain hydrogen ions in an amount of from 2x mol to less than 10x mol.

When the lithium-excess transition metal oxide Li₁₊ₓ(Mn_{y}M_{1-y})₁₋ₓO₂ is subjected to the acid treatment with an aqueous acid solution as described above, the amounts of lithium ions and hydrogen ions that are actually ion-exchanged do not reach the theoretical values. The reason is believed to be that, when lithium and hydrogen ions are ion-exchanged according to the above-described method, the ion-exchange reaction is not completed and an equilibrium state is reached before reaching the theoretical values.

In other words, according to the above-described method, it is possible to prevent lithium ions from being excessively extracted from the lithium-excess transition metal oxide Li₁₊ₓ(Mn_{y}M_{1-y})₁₋ₓO₂ (i.e., it is possible to allow an appropriate amount of lithium ions to be extracted). Therefore, when the positive electrode active material manufactured according to this method is used for the positive electrode of a non-aqueous electrolyte secondary battery, the difference between the amount of lithium ions extracted from the positive electrode during charge and the amount of lithium ions inserted into the positive electrode during discharge can be made smaller. This makes it possible to improve the initial charge-discharge efficiency of the non-aqueous electrolyte secondary battery sufficiently while at the same time maintaining a high capacity that is comparable to the case where the lithium-excess transition metal oxide Li₁₋ₓ(Mn_{y}M_{1-y})₁₋ₓO₂ is used as the positive electrode active material.

The lithium-excess transition metal oxide after being subjected to the acid treatment and washed with water was studied by thermogravimetric analysis. As a result, it was found that weight reduction of the lithium-excess transition metal oxide started when the ambient temperature reached about 200° C. and that the weight reduction stopped when the ambient temperature reached about 450° C. From the result, it is believed that when the lithium-excess transition metal oxide subjected to the acid treatment and washed with water is heat-treated in an atmosphere at 250° C. or higher as described above, hydrogen ions contained in the lithium-excess transition metal oxide produced by ion exchange with lithium ions can be extracted as H₂O by ion-exchange with lithium ions.

It is preferable that an aqueous nitric acid (HNO₃) solution be used as the aqueous acid solution. This makes it possible to prevent impurities from remaining in the above-described lithium-excess transition metal oxide after water-washing. Thereby, the battery performance can be improved.

It is preferable that the positive electrode mixture have a filling density of from greater than 2.5 g/cm³ to 3.6 g/cm³. It is also preferable that the positive electrode mixture layer have a thickness of 40 μm or less.

It is generally desirable that the filling density of the positive electrode mixture be as high as possible because the volumetric energy density of the battery accordingly becomes higher. However, if the filling density of the positive electrode mixture is too high, the impregnation capability with electrolyte solution becomes poor and consequently the battery performance becomes rather poor. For this reason, it is preferable that the upper limit of the filling density of the positive electrode mixture be 3.6 g/cm³ so that it becomes about 80% of the true density (about 4.5 g/cm³ at the maximum), as in the case of the positive electrode mixture using LiCoO₂ (the filling density: about 3.8 g/cm³ to 3.9 g/cm³=about 80% of the true density [5 g/cm³]).

Also, the present inventors have found through various experiments that, when the filling density of the positive electrode mixture is 2.5 g/cm³ or less, adhesion strength is insufficient between the positive electrode active material and the conductive agent within the positive electrode mixture and between the positive electrode mixture and the positive electrode current collector, and as a consequence, the load characteristics of the non-aqueous electrolyte secondary battery deteriorate. For this reason, it is preferable that the filling density of the positive electrode mixture is greater than 2.5 g/cm³.

It is desirable that the film thickness of the positive electrode mixture be as large as possible in order to increase the energy density of the secondary battery. However, if the film thickness of the positive electrode mixture is too large, the impregnation capability with electrolyte solution becomes poor, degrading the diffusion rate of lithium ions. Consequently, the discharge capacity deteriorates especially during high rate discharge. In the present embodiment, the film thickness of the positive electrode mixture layer is 40 μm or less. Therefore, good impregnation capability with electrolyte solution is obtained, and the discharge capacity density during high rate discharge is improved.

It is not particularly necessary to add a conductive agent to the positive electrode mixture containing the above-described positive electrode active material when the positive electrode mixture contains a positive electrode active material with good conductivity, but when using a positive electrode active material with low conductivity, it is preferable to add a conductive agent.

Any material having electrical conductivity may be used as the conductive agent. At least one substance among oxides, carbides, nitrides and carbon materials that have particularly good conductivity may be used.

Examples of the oxides with good conductivity include tin oxide and oxidized indium. Examples of the carbides with good conductivity include titanium carbide (TiC), tantalum carbide (TaC), niobium carbide (NbC), zirconium carbide (ZrC), and tungsten carbide (WC).

Examples of the nitrides with good conductivity include titanium nitride (TiN), tantalum nitride (TaN), niobium nitride (NbN), and tungsten nitride (WN). Examples of the carbon materials with good conductivity include Ketjen Black, acetylene black, and graphite.

When the amount of conductive agent is small, the conductivity of the positive electrode mixture cannot be enhanced sufficiently. On the other hand, when the amount of conductive agent is too large, a high density cannot be obtained because the relative proportion of the positive electrode active material contained in the positive electrode mixture becomes small. For this reason, the amount of conductive agent should be from 0 weight % to 30 weight % with respect to the total amount of the positive electrode mixture, preferably from 0 weight % to 20 weight %, and more preferably from 0 weight % to 10 weight %.

Examples of the binder agent to be added when preparing the positive electrode mixture include polytetrafluoroethylene, polyvinylidene fluoride, polyethylene oxide, polyvinyl acetate, polymethacrylate, polyacrylate, polyacrylonitrile, polyvinyl alcohol, styrene-butadiene rubber, and carboxymethylcellulose, either alone or in combination.

When the amount of the binder agent added is too large, a high energy density cannot be obtained because the relative proportion of the positive electrode active material contained in the positive electrode mixture becomes small. For this reason, the amount of the conductive agent added should be from 0 weight % to 30 weight % with respect to the total amount of the positive electrode mixture, preferably from 0 weight % to 20 weight %, and more preferably from 0 weight % to 10 weight %.

In the present embodiment, the amounts of conductive agent and binder agent are determined so that the filling density of the positive electrode mixture will be from greater than 2.5 g/cm³ to 3.6 g/cm³, as mentioned above.

(2) Non-Aqueous Electrolyte

The non-aqueous electrolyte may be prepared by dissolving an electrolyte salt in a non-aqueous-solvent.

Examples of the non-aqueous solvent include non-aqueous solvents that are used for common batteries, such as cyclic carbonic esters (carbonates), chain carbonic esters, esters, cyclic ethers, chain ethers, nitrites, amides, and combinations thereof.

Examples of the cyclic carbonic esters include ethylene carbonate, propylene carbonate and butylene carbonate. It is also possible to use a cyclic carbonic ester in which part or all of the hydrogen groups of the just-mentioned cyclic carbonic esters is/are fluorinated, such as trifluoropropylene carbonate and fluoroethylene carbonate.

Examples of the chain carbonic esters include dimethyl carbonate, ethyl methyl carbonate, diethyl carbonate, methyl propyl carbonate, ethyl propyl carbonate, and methyl isopropyl carbonate. It is also possible to use a chain carbonic ester in which part or all of the hydrogen groups of one of the foregoing chain carbonic esters is/are fluorinated.

Examples of the esters include methyl acetate, ethyl acetate, propyl acetate, methyl propionate, ethyl propionate, and γ-butyrolactone. Examples of the cyclic ethers include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and crown ether.

Examples of the chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butylphenyl ether, pentylphenyl ether, methoxytoluene, benzyl ethyl ether, diphenyl ether, dibenzyl ether, o-dimethoxybenzene, 1,2-diethoxyethane, 1,2-dibutoxy ethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Examples of the nitriles include acetonitrile, and examples of the amides include dimethylformamide.

The non-aqueous solvent may be at least one of the foregoing examples.

In the present embodiment, it is possible to use any electrolyte salt that is commonly used as an electrolyte salt in the conventional non-aqueous electrolyte secondary batteries.

Specific examples of the electrolyte salt include lithium hexafluorophosphate (LiPF₆), lithium tetrafluoroborate (LiBF₄), LiCF₃SO₃, LiC₄F₉SO₃, LiN(CF₃SO₂)₂, LiN(C₂F₅SO₂)₂, LiAsF₆, and lithium difluoro(oxalato)borate. These electrolyte salts may be used alone or in combination.

The present embodiment employs a non-aqueous electrolyte in which lithium hexafluorophosphate as an electrolyte salt is added at a concentration of 1 mol/L to a mixed non-aqueous solvent of 30:70 volume ratio of ethylene carbonate and diethyl carbonate.

(3) Negative Electrode

The present embodiment employs a material capable of intercalating and deintercalating lithium ions for the negative electrode. Examples of such a material include metallic lithium, lithium alloys, carbon materials such as graphite, and silicon (Si).

(4) Preparation of Non-Aqueous Electrolyte Secondary Battery

A method of preparing a non-aqueous electrolyte secondary battery using the positive electrode, the negative electrode, and the non-aqueous electrolyte will be described below. Herein, a method of preparing a test cell having a positive electrode (working electrode), a negative electrode (counter electrode), and a reference electrode will be described.

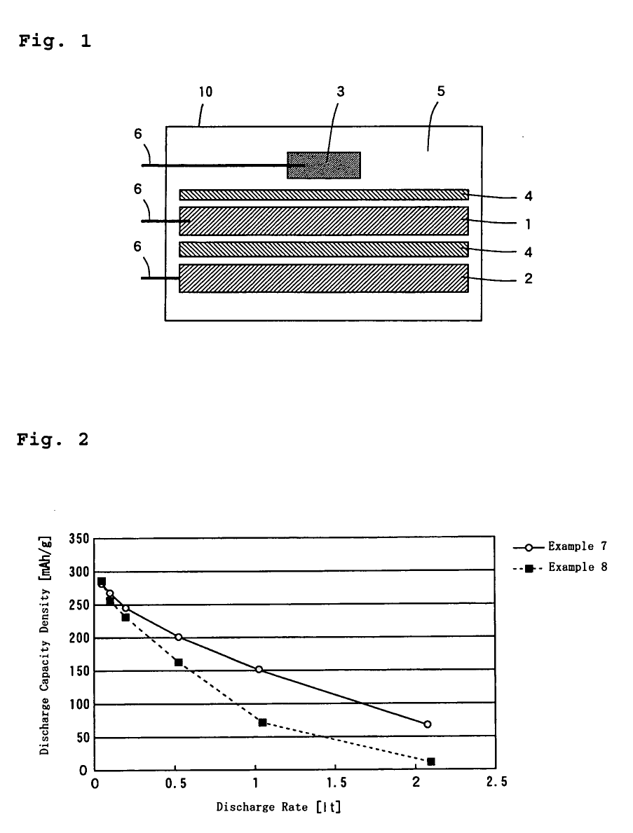

FIG. 1 is a schematic illustrative drawing illustrating a test cell of the non-aqueous electrolyte secondary battery according to the present embodiment.

As illustrated in FIG. 1, a lead wire 6 is attached to the positive electrode 1 in an inert atmosphere, and likewise, a lead wire 6 is attached to the negative electrode 2 made of metallic lithium.

Next, a separator 4 is interposed between the positive electrode 1 and the negative electrode 2, and then, the positive electrode 1, the negative electrode 2, and a reference electrode 3 are disposed in a laminate container 10. The reference electrode 3 is made of, for example, metallic lithium. Thereafter, a non-aqueous electrolyte 5 prepared in the foregoing manner is filled in the laminate container 10, to thus prepare a test cell as a non-aqueous electrolyte secondary battery. Note that a separator 4 is interposed also between the positive electrode 1 and the reference electrode 3.

(5) Advantageous Effects Obtained in the Present Embodiment

The non-aqueous electrolyte secondary battery according to the present embodiment uses Li₁₊ₓ₋ₐ(Mn_{y}M_{1-y})₁₋ₓO_{2±b} (where 0<a<0.3, 0<b<0.1, 0<x<0.4, 0<y<1, and 0.95<1+x−a<1.15, and M is a transition metal) as the positive electrode active material.

In this positive electrode active material, the amount of lithium per 1 mol of the positive electrode active material is within an appropriate range. Therefore, the difference between the amount of lithium ions (Li⁺) extracted from the positive electrode during charge and the amount of lithium ions inserted into the positive electrode during discharge can be made smaller. Thereby, it becomes possible to obtain a positive electrode active material that can improve the initial charge-discharge efficiency of the non-aqueous electrolyte secondary battery sufficiently while at the same time maintaining a high capacity that is comparable to the lithium-excess transition metal oxide Li₁₊ₓ(Mn_{y}M_{1-y})₁₋ₓO₂.

Moreover, the true density of the positive electrode active material according to the present embodiment is higher than that of the conventional positive electrode active material Li₁₊ₓM₁₋ₓO₂, which is not subjected to the acid treatment. As a result, the non-aqueous electrolyte secondary battery is allowed to have a high energy density.

As a result, it becomes possible to improve the load characteristics and the initial charge-discharge efficiency of the non-aqueous electrolyte secondary battery, while at the same time maintaining a high capacity.

### EXAMPLES

In Examples 1 to 8 and Comparative Examples 1 to 7, test cells of the non-aqueous electrolyte secondary battery were fabricated using positive electrode active materials of various compositions, and the charge-discharge characteristics of the fabricated test cells were studied.

(1) Test Cells

### (a) Example 1

In Example 1, a positive electrode 1 was prepared in the following manner.

Lithium hydroxide (LiOH) and Mn_{0.67}Ni_{0.17}Co_{0.17}(OH)₂ prepared by coprecipitatation were used as the starting materials of a lithium-excess transition metal oxide. These substances were mixed so as to be in a desired stoichiometric ratio, and the mixed powder was formed into pellets. Thereafter, the pellets were sintered in the air at 900° C. for 24 hours. Thus, a lithium-excess transition metal oxide Li_{1.20}Mn_{0.54}Ni_{0.13}Co_{0.13}O₂ was obtained.

Next, an acid treatment was carried out by stirring the lithium-excess transition metal oxide Li_{1.20}Mn_{0.54}Ni_{0.13}Co_{0.13}O₂ for 2 hours in an aqueous nitric acid (HNO₃) solution. In this acid treatment, an aqueous nitric acid solution in which the amount of hydrogen ions was 0.2 mol per 1 mol of the lithium-excess transition metal oxide Li_{1.20}Mn_{0.54}Ni_{0.13}Cu_{0.13}O₂ was used. Next, the lithium-containing transition metal oxide that was subjected to the acid treatment was water-washed and then heat-treated in an air atmosphere at 300° C. for 5 hours. Thereby, Li₁₊ₓ₋ₐ(Mn_{y}Ni_{z}Co_{1-y-x})₁₋ₓO_{2±b} was obtained as a positive electrode active material.

The resultant positive electrode active material and acetylene black as a conductive agent were mixed together so that the positive electrode active material and the conductive agent account for 80 weight % and 10 weight %, respectively, of the positive electrode mixture. Thereafter, polyvinylidene fluoride (PVdF) as a binder agent was added to the resultant mixture in an amount of 10 weight % with respect to the total amount of the positive electrode mixture. Further, NMP (N-methyl-2-pyrrolidone) was added thereto in an appropriate amount and mixed to prepare a slurry. The resultant slurry was applied to an aluminum (Al) foil with a coater and dried at 110° C. using a hot plate. The resultant material was cut into a size of 2 cm×2 cm, and then pressure-rolled with rollers, to prepare positive electrode. The resultant positive electrode was vacuum dried at 110° C., and thus, a positive electrode 1 was obtained.

Metallic lithium that was cut into a predetermined size was used as a negative electrode 2. Also, a reference electrode 3 was also prepared by cutting metallic lithium into a predetermined size.

Ethylene carbonate and diethyl carbonate were mixed in a proportion of 30:70 volume % to prepare a non-aqueous solvent. Lithium hexafluorophosphate (LiPF₆) as an electrolyte salt was added at a concentration of 1.0 mol/L to the mixed non-aqueous solvent. The resultant electrolyte was used as a non-aqueous electrolyte 5.

A test cell of the non-aqueous electrolyte secondary battery of Example 1 was prepared in the manner described in the foregoing preferred embodiment (FIG. 1), using the positive electrode 1, the negative electrode 2, the reference electrode 3, and the non-aqueous electrolyte 5, which were prepared in the just-described manner.

Specifically, the test cell was prepared as follows. In an inert atmosphere, respective lead wires 6 were attached to the positive electrode 1, the negative electrode 2, and the reference electrode 3. The positive electrode 1, the negative electrode 2, and the reference electrode 3 with the lead wires 6 were disposed in a laminate container 10. Then, separators 4 were interposed between the positive electrode 1 and the negative electrode 2 and between the positive electrode 1 and the reference electrode 3, and thereafter, the non-aqueous electrolyte 5 was filled in the laminate container 10.

### (b) Example 2

Example 2 differs from Example 1 in the following point.

In Example 2, the acid treatment was carried out by stirring the lithium-excess transition metal oxide Li_{1.20}Mn_{0.54}Ni_{0.13}Co_{0.13}O₂ for 6 hours in the aqueous nitric acid solution.

### (c) Example 3

Example 3 differs from Example 1 in the following point.

In Example 3, the acid treatment was carried out by stirring the lithium-excess transition metal oxide Li_{1.20}Mn_{0.54}Ni_{0.13}Co_{0.13}O₂ for 24 hours in the aqueous nitric acid solution.

### (d) Example 4

Example 4 differs from Example 1 in the following point.

In the acid treatment of Example 4, an aqueous nitric acid solution in which the amount of hydrogen ions was 0.5 mol per 1 mol of the lithium-excess transition metal oxide Li_{1.20}Mn_{0.54}Ni_{0.13}Co_{0.13}O₂ was used.

### (e) Example 5

Example 5 differs from Example 4 in the following point.

In Example 5, the acid treatment was carried out by stirring the lithium-excess transition metal oxide Li_{1.20}Mn_{0.54}Ni_{0.13}Co_{0.13}O₂ for 6 hours in the aqueous nitric acid solution.

### (f) Example 6

Example 6 differs from Example 4 in the following point.

In Example 6, the acid treatment was carried out by stirring the lithium-excess transition metal oxide Li_{1.20}Mn_{0.54}Ni_{0.13}Co_{0.13}O₂ for 24 hours in the aqueous nitric acid solution.

### (g) Example 7

In Example 7, a test cell was fabricated in the same conditions as described in Example 1 except that the positive electrode mixture had a filling density of 3.2 g/cm³ and a film thickness of 20 μm.

### (h) Example 8

Example 8 differs from Example 7 in the following point.

In Example 8, the filling density of the positive electrode mixture was set at 2.5 g/cm³.

### (i) Comparative Example 1

Comparative Example 1 differs from Example 1 in the following point.

In the acid treatment of Comparative Example 1, an aqueous nitric acid solution in which the amount of hydrogen ions was 0.1 mol per 1 mol of the lithium-excess transition metal oxide Li_{1.20}Mn_{0.54}Ni_{0.13}Co_{0.13}O₂ was used.

### (j) Comparative Example 2

Comparative Example 2 differs from Comparative Example 1 in the following point.

In Comparative Example 2, the acid treatment was carried out by stirring the lithium-excess transition metal oxide Li_{1.20}Mn_{0.54}Ni_{0.13}Co_{0.13}O₂ for 6 hours in the aqueous nitric acid solution.

### (k) Comparative Example 3

Comparative Example 3 differs from Comparative Example 1 in the following point.

In Comparative Example 3, the acid treatment was carried out by stirring the lithium-excess transition metal oxide Li_{1.20}Mn_{0.54}Ni_{0.13}Co_{0.13}O₂ for 24 hours in the aqueous nitric acid solution.

### (l) Comparative Example 4

Comparative Example 4 differs from Comparative Example 1 in the following point.

In the acid treatment of Comparative Example 4, an aqueous nitric acid solution in which the amount of hydrogen ions was 1.0 mol per 1 mol of the lithium-excess transition metal oxide Li_{1.20}Mn_{0.54}Ni_{0.13}Co_{0.13}O₂ was used.

### (m) Comparative Example 5

Comparative Example 5 differs from Comparative Example 4 in the following point.

In Comparative Example 5, the acid treatment was carried out by stirring the lithium-excess transition metal oxide Li_{1.20}Mn_{0.54}Ni_{0.13}Cu_{0.13}O₂ for 6 hours in the aqueous nitric acid solution.

### (n) Comparative Example 6

Comparative Example 6 differs from Comparative Example 4 in the following point.

In Comparative Example 6, the acid treatment was carried out by stirring the lithium-excess transition metal oxide

Li_{1.20}Mn_{0.54}Ni_{0.13}Co_{0.13}O₂ for 24 hours in the aqueous nitric acid solution.

### (o) Comparative Example 7

Comparative Example 7 differs from Example 1 in the following point.

In Comparative Example 7, a lithium-excess transition metal oxide Li_{1.20}Mn_{0.54}Ni_{0.13}Co_{0.13}O₂ that was not subjected to the acid treatment was used as the positive electrode active material.

(2) Load Characteristic Test

Each test cell of the non-aqueous electrolyte secondary batteries of Examples 1 to 6 and Comparative Examples 1 to 7 was charged at a constant current of 0.05 It until the potential of the positive electrode 1 reached 4.8 V (end-of-charge potential) versus the reference electrode 3 and was thereafter discharged at a constant current of 0.05 It until the potential of the positive electrode 1 reached 2.0 V (end-of-discharge potential) versus the reference electrode 3, in order to obtain the charge capacity density, the discharge capacity density, and the initial charge-discharge efficiency.

The current value at which a rated capacity is completely discharged in 1 hour is referred as a rated current, which is denoted as 1.0 C. This can be represented as 1.0 It based on the SI unit system (International System of Unit). The charge capacity density and the discharge capacity density are the values obtained by dividing a battery capacity by the weight of the positive electrode active material. The conditions of the just-mentioned charge-discharge test are shown in Table 1.

TABLE 1
Charge conditions

| | | |
|---|---|---|
| End-of-charge potential: | 4.8 | V (vs. Li/Li+) |
| Charge current: | 0.05 | It |

Discharge conditions

| | | |
|---|---|---|
| End-of-discharge potential: | 2 | V (vs. Li/Li+) |
| Discharge current: | 0.05 | It |

In addition, Table 2 below shows the results of the charge-discharge tests for the test cells of Examples 1 to 6 and Comparative Examples 1 to 7 as well as the true densities of the positive electrode active materials of Examples 1 to 6 and Comparative Examples 1 to 7. It should be noted that the average potential is a mean value of the potentials in the charge-discharge range of 2.0 V to 4.8 V. The true density was measured by a gas replacement method.

TABLE 2

| | Acid treatment | | | | | | |
|---|---|---|---|---|---|---|---|
| | condition | | | | Initial | | |
| | Amount of | | Charge | Discharge | charge- | | |
| | hydrogen | Treatment | capacity | capacity | discharge | Average | True |
| | ion | duration | density | density | efficiency | potential | density |
| | (mol) | (hrs.) | (mAh/g) | (mAh/g) | (%) | (V) | (g/cm³) |
| Ex. 1 | 0.2 | 2 | 305.5 | 282.3 | 92.4 | 3.57 | 4.27 |
| Ex. 2 | 0.2 | 6 | 286.3 | 258.3 | 90.2 | 3.57 | 4.28 |
| Ex. 3 | 0.2 | 24 | 291.0 | 265.2 | 91.1 | 3.57 | 4.27 |
| Ex. 4 | 0.5 | 2 | 274.6 | 270.9 | 98.6 | 3.54 | 4.26 |
| Ex. 5 | 0.5 | 6 | 275.8 | 271.0 | 98.3 | 3.57 | 4.26 |
| Ex. 6 | 0.5 | 24 | 256.8 | 245.7 | 95.7 | 3.57 | 4.25 |
| Comp. | 0.1 | 2 | 316.1 | 273.0 | 86.4 | 3.59 | 4.27 |
| Ex. 1 | | | | | | | |
| Comp. | 0.1 | 6 | 303.0 | 263.1 | 86.8 | 3.60 | 4.28 |
| Ex. 2 | | | | | | | |
| Comp. | 0.1 | 24 | 303.1 | 262.9 | 86.7 | 3.59 | 4.28 |
| Ex. 3 | | | | | | | |
| Comp. | 1.0 | 2 | 232.5 | 241.1 | 103.7 | 3.51 | 4.22 |
| Ex. 4 | | | | | | | |
| Comp. | 1.0 | 6 | 244.6 | 259.9 | 106.3 | 3.49 | 4.22 |
| Ex. 5 | | | | | | | |
| Comp. | 1.0 | 24 | 232.9 | 253.3 | 108.8 | 3.50 | 4.22 |
| Ex. 6 | | | | | | | |

| | | | | | | |
|---|---|---|---|---|---|---|
| Comp. | N/A | 326.0 | 269.6 | 82.7 | 3.59 | 4.21 |
| Ex. 7 | | | | | | |

The positive electrode active materials Li₁₊ₓ₋ₐ(Mn_{y}Ni_{z}Co_{1-y-z})₁₋ₓO_{2±b} of Examples 1 to 6 and Comparative Examples 1 to 7 were analyzed by ICP (inductively coupled high frequency plasma) emission spectroscopy. Thereby, the composition ratios of lithium (Li), manganese (Mn), nickel (Ni), and cobalt (Co) therein were obtained. The results are shown in Table 3 below.

TABLE 3

| | Acid treatment | | | | | |
|---|---|---|---|---|---|---|
| | condition | | | | | |
| | Amount of | | | | | |
| | hydrogen | Treatment | Composition (mole ratio) | | | |
| | ion | duration | | Manga- | | |
| | (mol) | (hrs.) | Lithium | nese | Nickel | Cobalt |
| Ex. 1 | 0.2 | 2 | 1.120 | 0.536 | 0.134 | 0.130 |
| Ex. 2 | 0.2 | 6 | 1.132 | 0.538 | 0.133 | 0.128 |
| Ex. 3 | 0.2 | 24 | 1.120 | 0.537 | 0.134 | 0.129 |
| Ex. 4 | 0.5 | 2 | 1.008 | 0.537 | 0.134 | 0.127 |
| Ex. 5 | 0.5 | 6 | 1.010 | 0.539 | 0.134 | 0.129 |
| Ex. 6 | 0.5 | 24 | 0.989 | 0.540 | 0.133 | 0.127 |
| Comp. | 0.1 | 2 | 1.156 | 0.537 | 0.134 | 0.127 |
| Ex. 1 | | | | | | |
| Comp. | 0.1 | 6 | 1.154 | 0.538 | 0.133 | 0.129 |
| Ex. 2 | | | | | | |
| Comp. | 0.1 | 24 | 1.176 | 0.537 | 0.134 | 0.129 |
| Ex. 3 | | | | | | |
| Comp. | 1.0 | 2 | 0.920 | 0.538 | 0.134 | 0.128 |
| Ex. 4 | | | | | | |
| Comp. | 1.0 | 6 | 0.918 | 0.538 | 0.134 | 0.128 |
| Ex. 5 | | | | | | |
| Comp. | 1.0 | 24 | 0.906 | 0.540 | 0.134 | 0.127 |
| Ex. 6 | | | | | | |

| | | | | | |
|---|---|---|---|---|---|
| Comp. | N/A | 1.214 | 0.537 | 0.135 | 0.129 |
| Ex. 7 | | | | | |

For Examples 7 and 8, the test cells were charged and discharged successively in the following manners, to obtain the discharge capacity densities at the respective discharge rates. The test cells were charged under the above-described conditions and discharged at a constant current of 0.1 It. Then, the cells were charged under the above-described conditions and discharged at a constant current of 0.2 It. Then, the cells were charged under the above-described conditions and discharged at a constant current of 0.5 It. Thereafter, the cells were charged under the above-described conditions and discharged at a constant current of 1.0 It. Finally, the cells were charged under the above-described conditions and discharged at a constant current of 2.0 It. The conditions of the charge-discharge test are shown in FIG. 4.

TABLE 4
Charge conditions

| | |
|---|---|
| End-of-charge potential: | 4.8 V (vs. Li/Li⁺) |
| Charge current: | 0.05 It |

Discharge conditions

| | |
|---|---|
| End-of-discharge potential: | 2 V (vs. Li/Li⁺) |
| Discharge current: | 0.05 It × 3 cycles → 0.1 It × 3 cycles |
| | → 0.2 It × 3 cycles → 0.5 It × 3 cycles |
| | → 1.0 It × 3 cycles → 2.0 It × 3 cycles |

FIG. 2 shows a graph illustrating the relationship between discharge capacity density versus discharge rate for the test cells of Examples 7 and 8. For the test cells of Examples 7 and 8, the foregoing charge-discharge processes were carried out three times each. Each of the discharge capacity density values at the respective discharge rates shown in FIG. 2 is a mean value of the discharge capacity density values obtained in the charge-discharge processes performed three times at each discharge rate. In FIG. 2, the vertical axis represents discharge capacity density and the horizontal axis represents discharge rate.

(3) Evaluation

The results shown in Table 2 demonstrate that the test cells of Examples 1 to 6 exhibited significant improvements in charge-discharge efficiency while at the same time ensuring high discharge capacity densities comparable to the discharge capacity density of test cell of Comparative Example 7, which used the lithium-excess transition metal oxide Li_{1.20}Mn_{0.54}Ni_{0.13}Co_{0.13}O₂ as the positive electrode active material. On the other hand, the test cells of Comparative Examples 1 to 3 did not show sufficient improvements in charge-discharge efficiency.

As shown in Table 3, in the positive electrode active materials of Examples 1 to 6, the composition ratio of lithium was less than 1.15, whereas in the positive electrode active materials of Comparative Examples 1 to 3, the composition ratio of lithium was 1.15 or greater. This demonstrates that, when the composition ratio of lithium in the positive electrode active material is too large, the amount of lithium ions extracted by the acid treatment is insufficient, making it difficult to improve the initial charge-discharge efficiency.

In addition, in the test cells of Comparative Examples 4 to 6, both of the charge capacity density and the discharge capacity density were lower than those in the test cell of Comparative Example 7.

As shown in Table 2, in Comparative Examples 4 to 6, the charge-discharge efficiency values were greater than 100%, so it is believed that lithium ions were extracted excessively from the positive electrode active materials by the acid treatment. In addition, as shown in Table 3, in the positive electrode active materials of Comparative Examples 4 to 6, the composition ratio of lithium was 0.920 or less. Therefore, it is believed that when the composition ratio of lithium is small in the positive electrode active material, an excessive amount of lithium ions are extracted from the positive electrode active material during the acid treatment, and as a consequence, the amount of lithium ions involved in charge and discharge reduces in the positive electrode active material. Thus, the problem of poor charge-discharge capacity arises when the positive electrodes of Comparative Examples 4 to 6 are used for actual batteries using a carbon negative electrode or the like that does not contain lithium ions.

From the foregoing, it is demonstrated that, by controlling the composition ratio of lithium to be greater than 0.95 and less than 1.15 in the positive electrode active material Li₁₊ₓ₋ₐ(Mn_{y}Ni_{z}Co_{1-y-z})₁₋ₓO_{2±b} the initial charge-discharge efficiency can be improved significantly while at the same time a high capacity is maintained. It should be noted that, as seen from the results of the measurements for Examples 1 to 6 shown in Tables 2 and 3, it is more preferable that the composition ratio of lithium be controlled to be greater than 0.98.

In addition, as shown in Table 2, the true densities of the positive electrode active materials of Examples 1 to 6 are higher than the true density of the positive electrode active material of Comparative Example 7. From this, it is demonstrated that the true density of the lithium-excess transition metal oxide Li_{1.20}Mn_{0.54}Ni_{0.13}Co_{0.13}O₂ can be increased by acid-treating the lithium-excess transition metal oxide.

It is also seen from Table 3 that, when the acid treatment is carried out using an aqueous nitric acid solution in which the amount of hydrogen ions is 0.1 mol per 1 mol of the lithium-excess transition metal oxide Li_{1.20}Mn_{0.54}Ni_{0.13}Co_{0.13}O₂, the amount of lithium ions extracted from the positive electrode active material will be too small.

It is also seen from Table 3 that, when the acid treatment is carried out using an aqueous nitric acid solution in which the amount of hydrogen ions is 1.0 mol per 1 mol of the lithium-excess transition metal oxide Li_{1.20}Mn_{0.54}Ni_{0.13}Co_{0.13}O₂, the amount of lithium ions extracted from the positive electrode active material will be too large.

It is also seen from Table 3 that lithium ions can be extracted in an appropriate amount from the positive electrode active material when the acid treatment is carried out using an aqueous nitric acid solution in which the amount of hydrogen ions is 0.2 mol per 1 mol of the lithium-excess transition metal oxide Li_{1.20}Mn_{0.54}Ni_{0.13}Co_{0.13}O₂ and when using an aqueous nitric acid solution in which the amount of hydrogen ions is 0.5 mol per 1 mol of the lithium-excess transition metal oxide Li_{1.20}Mn_{0.54}Ni_{0.13}Co_{0.13}O₂.

Thus, it is demonstrated that the amount of hydrogen ions in the aqueous nitric acid solution used for the acid treatment should preferably be from 0.2 mol to less than 1.0 mol per 1 mol of the lithium-excess transition metal oxide Li_{1.20}Mn_{0.54}Ni_{0.13}Co_{0.13}O₂. Therefore, when the acid treatment is performed for the lithium-excess transition metal oxide Li₁₊ₓ(Mn_{y}M_{1-y})₁₋ₓO₂, it is preferable that the amount of hydrogen ions in the aqueous acid solution used for the acid treatment be in the range of from x mol to less than 5x mol (where 0<x<0.4) per 1 mol of the lithium-excess transition metal oxide Li₁₊ₓ(Mn_{y}M_{1-y})₁₋ₓO₂.

It should be noted that, as clearly seen from Table 3, the amounts of extracted lithium ions did not show a large difference between the cases where the duration of the acid treatment was short (i.e., 2 hours) and long (24 hours).

As shown in FIG. 2, in the case of high rate discharge, the discharge capacity density of the test cell of Example 7 is sufficiently greater than that of Example 8. This is believed due to the fact that by increasing the filling density of the positive electrode mixture, adhesion strength improves between the positive electrode active material and the conductive agent within the positive electrode mixture and between the positive electrode mixture and the positive electrode current collector, and accordingly, the load characteristics of the non-aqueous electrolyte secondary battery improve. As a result, it is believed that in the test cell of Example 7, the load characteristics were improved while at the same time maintaining a high capacity.

The non-aqueous electrolyte secondary battery and the positive electrode according to the present invention may be used as a power source for various applications, such as portable power sources and power sources for automobiles.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese patent application No. 2007-165821 filed Jun. 25, 2007, which is incorporated herein by reference.

What is claimed is:

1. A positive electrode active material comprising a lithium-containing oxide, said lithium-containing oxide comprising Li₁₊ₓ₋ₐ(Mn_{y}M_{1-y})₁₋ₓO_{2±b} where 0<a<0.3, 0<b<0.1, 0<x<0.4, 0<y<1, and 0.95<1+x−a<1.15, and M comprises at least one transition metal other than manganese.

2. The positive electrode active material according to claim 1, wherein said lithium-containing oxide comprises Li₁₊ₓ₋ₐ(Mn_{y}Ni_{z}Co_{1-y-z})₁₋ₓO_{2±b}, where 0<a<0.3, 0<b<0.1, 0<x<0.4, 0<y<1, 0<z<1, and 0.95<1+x−a<1.15.

3. The positive electrode active material according to claim 2, wherein said lithium-containing oxide comprises Li_{c}Mn_{0.54}Ni_{0.13}Co_{0.13}O_{2±b}, where 0<b<0.1 and 0.98<c<1.15.

4. The positive electrode active material according to claim 1, having a true density of from 4.25 g/cm³ to 4.28 g/cm³.

5. The positive electrode active material according to claim 2, having a true density of from 4.25 g/cm³ to 4.28 g/cm³.

6. The positive electrode active material according to claim 3, having a true density of from 4.25 g/cm³ to 4.28 g/cm³.

7. A method of manufacturing a positive electrode active material by obtaining the positive electrode active material from a lithium-containing oxide, comprising:
treating said lithium-containing oxide with an aqueous acid solution, wherein
the lithium-containing oxide comprises Li₁₊ₓ(Mn_{y}M_{1-y})₁₋ₓO₂ where 0<x<0.4 and 0<y<1, and M includes at least one transition metal other than manganese, and
the amount of hydrogen ions in the aqueous acid solution is from x mol to less than 5x mol per 1 mol of said lithium-containing oxide.

8. The method according to claim 7, wherein said aqueous acid solution is an aqueous nitric acid solution.

9. The method according to claim 7, further comprising, after the step of treating said lithium-containing oxide with said aqueous acid solution, a step of heat treating said lithium-containing oxide in an atmosphere at 250° C. or higher.

10. The method according to claim 8, further comprising, after the step of treating said lithium-containing oxide with said aqueous acid solution, a step of heat treating said lithium-containing oxide in an atmosphere at 250° C. or higher.

11. A non-aqueous electrolyte secondary battery comprising:
a positive electrode having a positive electrode mixture, a negative electrode, and a non-aqueous electrolyte,
the positive electrode mixture comprising a positive electrode active material according to claim 1.

12. A non-aqueous electrolyte secondary battery comprising:
a positive electrode having a positive electrode mixture, a negative electrode, and a non-aqueous electrolyte,
the positive electrode mixture comprising a positive electrode active material according to claim 2.

13. A non-aqueous electrolyte secondary battery comprising:
a positive electrode having a positive electrode mixture, a negative electrode, and a non-aqueous electrolyte,
the positive electrode mixture comprising a positive electrode active material according to claim 3.

14. The non-aqueous electrolyte secondary battery according to claim 11, wherein the positive electrode mixture has a filling density of from greater than 2.5 g/cm³ to 3.6 g/cm³.

15. The non-aqueous electrolyte secondary battery according to claim 12, wherein the positive electrode mixture has a filling density of from greater than 2.5 g/cm³ to 3.6 g/cm³.

16. The non-aqueous electrolyte secondary battery according to claim 13, wherein the positive electrode mixture has a filling density of from greater than 2.5 g/cm³ to 3.6 g/cm³.

17. The non-aqueous electrolyte secondary battery according to claim 11, wherein the positive electrode mixture layer has a thickness of 40 μm or less.

18. The non-aqueous electrolyte secondary battery according to claim 12, wherein the positive electrode mixture layer has a thickness of 40 μm or less.

19. The non-aqueous electrolyte secondary battery according to claim 13, wherein the positive electrode mixture layer has a thickness of 40 μm or less.
